(19) United States
(12) Patent Application Publication
(10) Pub. No.: US 2014/0197779 A1
(43) Pub. Date: Jul. 17, 2014

(54) ELECTRONIC DEVICE, METHOD FOR CONTROLLING THE ELECTRONIC DEVICE AND CONTROL PROGRAM FOR THE ELECTRONIC DEVICE

(71) Applicant: Kabushiki Kaisha Toshiba, Tokyo (JP)

(72) Inventor: Yutaka HORIE, Mitaka-shi (JP)

(73) Assignee: Kabushiki Kaisha Toshiba, Tokyo (JP)

(21) Appl. No.: 13/975,925

(22) Filed: Aug. 26, 2013

Related U.S. Application Data
(63) Continuation of application No. PCT/US2013/058622, filed on Mar. 25, 2013.

(30) Foreign Application Priority Data
Jan. 11, 2013 (JP) 2013-003836

(51) Int. Cl. H02J 7/00

(52) U.S. Cl. CPC H02J 7/0052
USPC 320/107; 320/137

(57) ABSTRACT

According to one embodiment, an electronic device includes a charging controller, a first information detector, an elapsed time information detector, and a charging instruction module. The controller performs control for charging a battery with a first charging value. The first information detector detects first use date and time information stored in a storage unit of the battery. The elapsed time information detector obtains elapsed time information based on the detected first use date and time information, and detects whether the elapsed time information corresponds to a preset value. The charging instruction module provides an instruction to change a charging value to a preset second charging value when the elapsed time information corresponds to the preset value.

### CROSS REFERENCE TO RELATED APPLICATIONS

This application is a Continuation Application of PCT Application No. PCT/JP2013/058622, filed Mar. 25, 2013 and based upon and claiming the benefit of priority from Japanese Patent Application No. 2013-003836, filed Jan. 11, 2013, the entire contents of all of which are incorporated herein by reference.

### FIELD

Embodiments described herein relate generally to an electronic device, a method for controlling the electronic device and a control program for the electronic device.

### BACKGROUND

Electronic devices, such as a personal computer (PC) which can be driven by a battery as a power source, have recently come into widespread use.

The electronic devices can be held and carried by a user, for example.

It is known that a battery used in the electronic devices is degraded as time passes, for example. For example, a technique of determining a degradation of the battery on the basis of charging time and charging frequency of the battery is proposed.

However, the above technique has the problem that it is complicated and inconvenient for a user to note a degradation of a battery used in an electronic device whenever the user uses the electronic device.

Therefore, there is a need for increasing user convenience by control of charge particularly without noting a degradation of a battery used in an electronic device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating an outward appearance of an electronic device (PC) according to an embodiment.

FIG. 2 is a block diagram illustrating a configuration of the electronic device (PC) according to the embodiment.

FIG. 3 is a block diagram illustrating a main part of the configuration of the electronic device (PC) according to the embodiment.

FIG. 4 is a flowchart describing an operation of the electronic device (PC) according to the embodiment.

### DETAILED DESCRIPTION

Various embodiments will be described hereinafter with reference to the accompanying drawings.

In general, according to one embodiment, an electronic device includes a charging controller configured to perform control for charging a battery with a preset first charging value.

The device also includes a first information detector configured to detect first use date and time information stored in a storage unit of the battery.

The device also includes an elapsed time information detector configured to obtain elapsed time information based on the detected first use date and time information, and detect whether the elapsed time information corresponds to a preset value.

The device also includes a charging instruction module configured to provide an instruction to switch a charging value to a preset second charging value and charge the battery when the elapsed time information corresponds to the preset value.

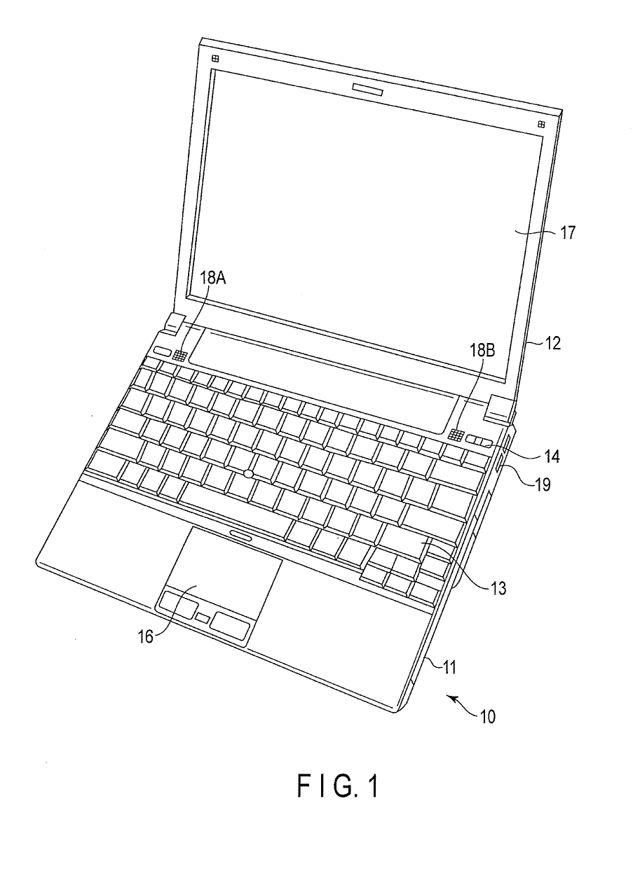

FIG. 1 is a view showing an outward appearance of an electronic device (PC) according to the embodiment.

In this embodiment, an electronic device (PC) 10 is achieved as, for example, a notebook type personal computer (a notebook PC or a PC).

The electronic device (PC) 10 according to the embodiment is not limited to a personal computer but can be applied to a tablet PC, a cellular phone, a smartphone, a portable electronic device, a television set and the like.

This embodiment will be described using a personal computer (PC) as an example of the electronic device 10.

The electronic device (PC) 10 includes, for example, a computer (a notebook PC) main body 11 and a video display unit 12. The video display unit 12 incorporates, for example, a liquid crystal display (LCD) 17.

The video display unit 12 is attached to the computer (notebook PC) main body 11 such that it can be turned between an open position in which the top surface of the computer (notebook PC) main body 11 is exposed and a closed position in which the top surface of the computer (notebook PC) main body 11 is covered with the video display unit 12.

The computer (notebook PC) body 11 includes a thin box-shaped housing and its top surface is provided with a keyboard 13, a power button 14 for turning on/off the electronic device (PC) 10, a touch pad 16, speakers 18A and 18B, and the like.

The computer (notebook PC) body 11 also includes a universal serial bus (USB) connector 19 on its right side, for example. The USB connector 19 is provided to connect a USB device, and a USB cable of the USB 2.0 standard.

Furthermore, the computer (notebook PC) body 11 includes on its back surface an external display connection terminal (not shown) which conforms to, for example, the high-definition multimedia interface (HDMI) standard. The external display connection terminal is used to output a digital video signal to an external display.

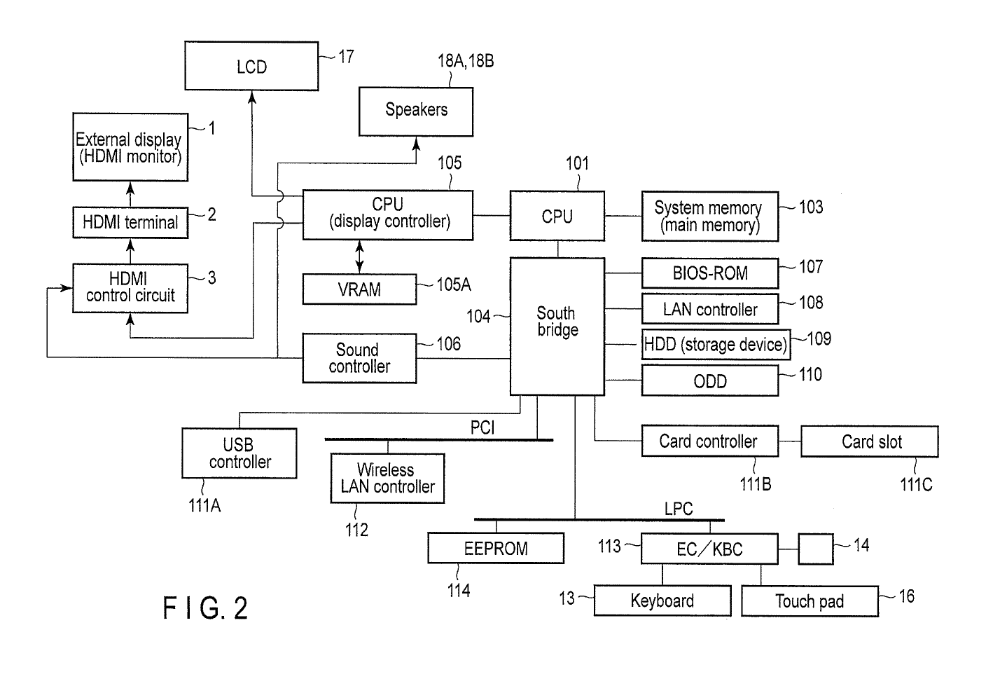

FIG. 2 is a block diagram showing a configuration of the electronic device (PC) according to the embodiment.

As shown in FIG. 2, for example, the electronic device (PC) 10 includes a central processing unit (CPU) 101, a system memory (main memory) 103, a south bridge 104, a graphics processing unit (GPU) 105, a video RAM (VRAM: a video random access memory) 105A, a sound controller 106, a basic input/output system-read only memory (BIOS-ROM) 107, a local area network (LAN) controller 108, a hard disk drive (HDD: storage device) 109, an optical disk drive (ODD) 110, a USB controller 111A, a card controller 111B, a card slot 111C, a wireless LAN controller 112, an embedded controller/keyboard controller (EC/KBC) 113, an electrically erasable programmable ROM (EEPROM) 114, and the like.

The CPU (SOC) 101 is a processor that controls the operation of each of the units in the electronic device (PC) 10.

The CPU (SOC) 101 executes a BIOS stored in the BIOS-ROM 107. The BIOS is a program for controlling hardware. The CPU (SOC) 101 also includes a memory controller for controlling access to the system memory (main memory) 103. Furthermore, the CPU (SOC) 101 has a function of carrying out communications with the GPU 105 via a serial bus of the PCI EXPRESS standard, for example.

The GPU 105 is a display controller that controls the LCD 17 used as a display monitor of the electronic device (PC) 10.

The GPU 105 generates a display signal and sends it to the LCD 17. The GPU 105 is also able to send a digital video signal to an external display 1 via an HDMI control circuit 3 and an HDMI terminal 2.

The HDMI terminal 2 is the external display connection terminal described above. The HDMI terminal 2 is able to send an uncompressed digital video signal and digital audio signal to the external display 1 such as a television set through a single cable. The HDMI control circuit 3 is an interface for sending a digital video signal to the external display 1, which is referred to as an HDMI monitor, via the HDMI terminal 2.

The south bridge 104 controls the devices on a peripheral component interconnect (PCI) bus and the devices on a low pin count (LPC) bus. Furthermore, the south bridge 104 includes an integrated drive electronics (IDE) controller for controlling the HDD 109 and the ODD 110.

The south bridge 104 also has a function of carrying out communications with the sound controller 106.

The sound controller 106 is a sound source device to output audio data to be reproduced to the speakers 18A and 18B or the HDMI control circuit 3. The LAN controller 108 is a wired communication device of, e.g., the IEEE 802.3 standard, which carries out wired communications, while the wireless LAN controller 112 is a wireless communication device of, e.g., the IEEE 802.11g standard, which carries out wireless communications. The USB controller 111A carries out communications with an external device that conforms to the USB 2.0 standard, for example.

For example, the USB controller 111A is used to receive an image data file stored in a digital camera. The card controller 111B writes/reads data to/from a memory card, such as an SD card, which is inserted into a card slot provided in the computer (notebook PC) body 11.

The EC/KBC 113 is a one-chip micro computer in which an embedded controller for power management and a keyboard controller for controlling the keyboard 13 and touch pad 16 are integrated. The EC/KBC 113 has a function of turning on/off the electronic device (PC) 10 according to a user operation of the power button 14.

The display control in the embodiment is performed by executing the programs recorded in, for example, the system memory (main memory) 103 and the HDD 109 by the CPU (SOC) 101.

In the present embodiment, OS is an abbreviation of the operating system.

The OS provides basic functions, such as an input/output function (input from the keyboard, and output of screen image) and a management function of managing the disk and memory, which are used in common from a number of applications software. In this embodiment, the OS is stored in, for example, the HDD 109.

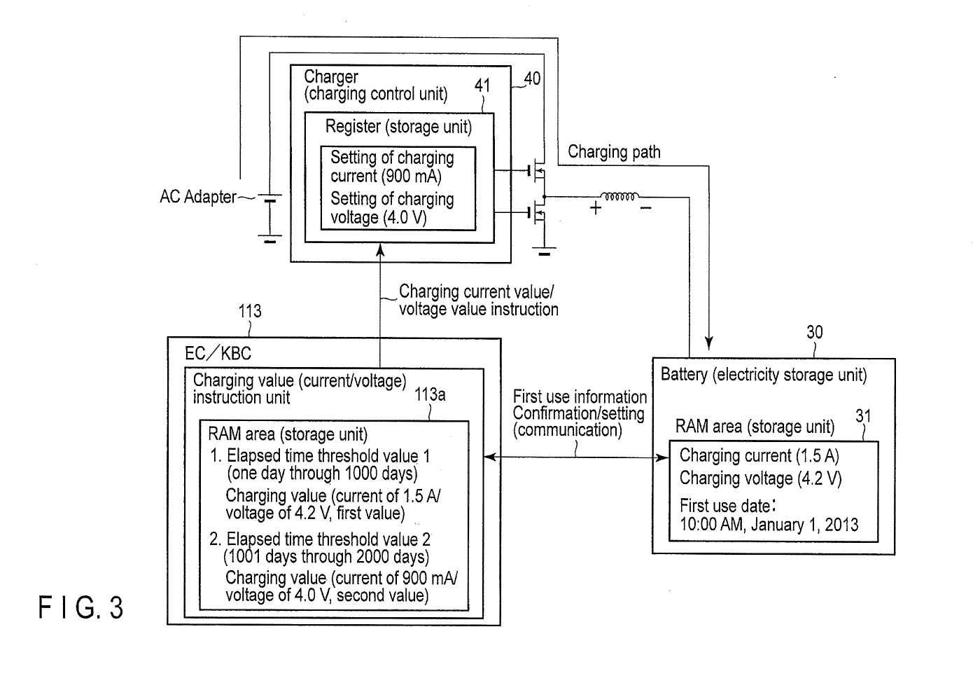

FIG. 3 is a block diagram showing a main part of the configuration of the electronic device (PC) according to the embodiment.

In this embodiment, as shown in FIG. 3, the electronic device (PC) 10 includes a charging control unit (charger) 40, and the charging control unit (charger) 40 performs control for charging of a battery 30 with a first charging value (e.g., current of 1.5 A/voltage of 4.2 V) which is preset in the storage unit (register) 41.

In this embodiment, the battery 30 is configured to include a plurality of cells of, e.g., 3000 mAh.

The electronic device (PC) 10 employs, for example, the EC/KBC 113 to detect “first use date and time information” (e.g., first use date: 10:00 AM, Jan. 1, 2013) stored in a storage unit (RAM area) 31 of the battery 30 (first information detector).

Hereinafter, the EC/KBC 113 will be described.

EC/KBC is an abbreviation of an embedded controller and a keyboard controller and the EC/KBC serves as a microcontroller.

The EC/KBC 113 confirms and controls the status of the electronic device (PC) 10 using different sensors and the others, irrespective of the power on/off state of the electronic device (PC) 10.

The EC/KBC 113 performs power control for turning on/off the system, monitors the temperatures of components, controls the number of revolutions of a radiating fan, monitors input using the button, keyboard and touch pad, and the like.

When, for example, the “first use date and time information” (first use date: 10:00 AM, Jan. 1, 2013) is detected, the electronic device (PC) 10 computes and acquires information (elapsed time information) indicative of “elapsed time” from the first use date and time to the present time on the basis of the “first use date and time information.”

The EC/KBC 113 detects whether the “elapsed time” information corresponds to a value (e.g., 2. elapsed time threshold value 2 (1001 days through 2000 days)) preset, as show in FIG. 3, in, for example, a storage unit (RAM area) 113a of the charging value instruction unit (EC/KBC) 113 (elapsed time information detector).

If the “elapsed time” information corresponds to the preset value (2. elapsed time threshold value 2 (1001 days through 2000 days)), or if the “elapsed time” from the first use date of the electronic device (PC) 10 corresponds to 1001 days through 2000 days, the EC/KBC 113 instructs the charging control unit (charger) 40 to switch a charging value from the first charging value to a second charging value (“charging value” (current of 900 mA/voltage of 4.0 V, second value)) preset in the storage unit (RAM area) 113a and charge the battery 30 (charging instruction unit).

More specifically, in the electronic device (PC) 10 according to the embodiment, when the OS is started, the charging value instruction unit (EC/KBC) 113 detects (confirms) information of the first use date (10:00 AM, Jan. 1, 2013) stored in the storage unit (RAM area) 31 in the battery 30, for example.

Then, if the information of the first use date (10:00 AM, Jan. 1, 2013) cannot be detected (confirmed) in the storage unit (RAM data area), starting date information indicative of the starting time of the OS is stored in the storage unit (register) 41 of the charging control unit (charger) 40 as the first use date.

After that, a charging value instruction unit (charging current and voltage determination block) in the EC/KBC 113 receives a charging start instruction to start charging the battery 30.

At the start of charging the battery 30, using, for example, the above “first use date and time information” (first use date), the “elapsed time” from the first use date to the present time is computed.

As the present time, for example, the time information of the electronic device (PC) 10 can be used.

The computed “elapsed time” is compared with the elapsed time threshold value (e.g., elapsed time threshold value 1: one day through 1000 days, and elapsed time threshold value 2: 1001 days through 2000 days), which is stored in the storage unit (RAM area) 31 of the charging value instruction unit (EC/KBC) 113.

If a give time (elapsed time threshold value 1: one day through 1000 days) does not elapse, the “charging value” (charging current of 1.5 A/charging voltage of 4.2 V, first value) stored in the storage unit (RAM area) 31 of the battery 30 is employed.

If the give time elapses (i.e., if the computed “elapsed time” corresponds elapsed time threshold value 2: 1001 days through 2000 days), the “charging value” (900 mA of charging current/4.0 V of charging voltage, second value) corresponding to the “elapsed time” is designated.

The charging value instruction unit (EC/KBC) 113 outputs the designated charging value information (first value: charging current of 1.5 A/charging voltage of 4.2 V, or second value: charging current of 900 mA/charging voltage of 4.0 V) to the charging control unit (charger) 40.

The charging control unit (charger) 40 charges the battery 30 using the designated “charging value” information.

In this embodiment, for example, the storage unit (register) 31 that stores the “first use date information” can be provided in the battery 30.

Furthermore, the charging value instruction unit (EC/KBC) 113 checks the first use date of the battery 30 in accordance with the start of the OS of the electronic device (PC) 10. If information of the first use date cannot be detected, the present OS start date can be registered as the first use date.

Moreover, the charging value instruction unit (EC/KBC) 113 computes elapsed time from the first use date at the start of charging the battery 30. If the elapsed time becomes longer than a given time, the charging voltage can be controlled (the charging voltage can be lowered, the charging current can be decreased, or the like) according to the “elapsed time.”

It is thus possible to improve safety in charging the battery 30, for example.

More specifically, in the electronic device according to the embodiment, it is possible to compute “elapsed time” from the start of use of the battery 30 by causing the battery 30 to have a function of registering the “first use date information” of the battery 30 in the battery 30.

In accordance with the computed “elapsed time,” the “charging value” (charging voltage, charging current, etc.) for charging the battery 30 can be changed.

It is thus possible to improve safety in charging the battery 30.

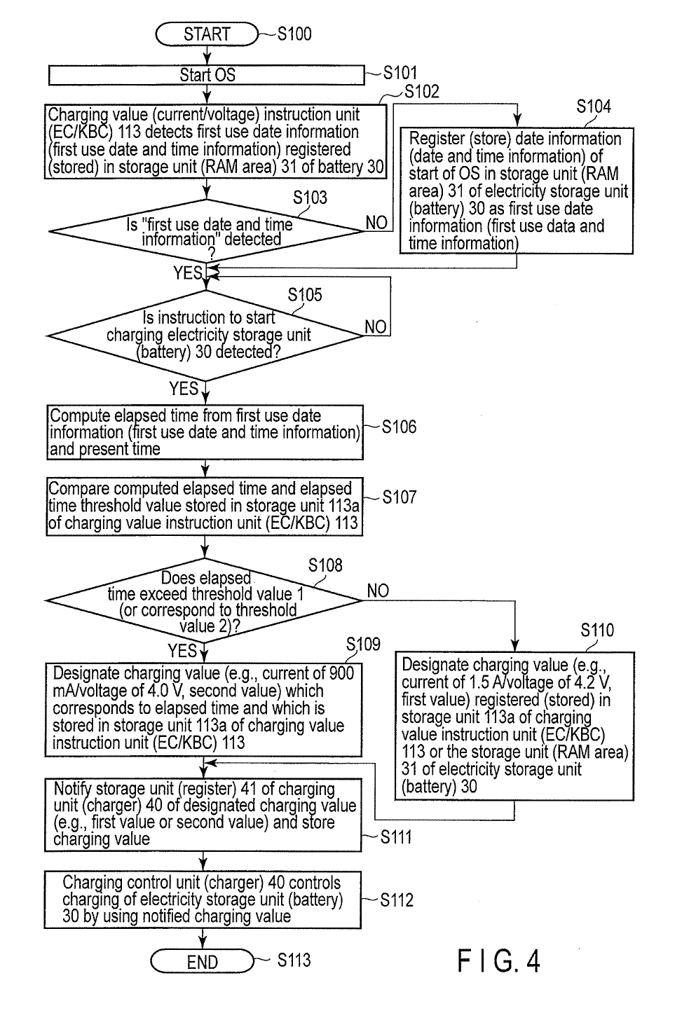

FIG. 4 is a flowchart describing an operation of the electronic device (PC) according to the embodiment.

In step S100, the operation starts. Then, the operation goes to step S101.

In step S101, for example, the electronic device (PC) 10 is powered on to start (boot) the OS. Then, the operation goes to step S102.

In step S102, when the OS starts, the charging value instruction unit (EC/KBC) 113 detects first use date information (first use date and time information) registered (stored) in the storage unit (RAM area) 31 of the battery 30. Then, the operation goes to step S103.

In step S103, it is determined whether the “first use date and time information” is detected. If it is determined that the “first use date and time information” is detected (Yes), the operation goes to step S105. If it is determined that the “first use date and time information” is not detected (No), the operation goes to step S104.

In step S104, the date information (date and time information) indicative of the present starting time of the OS is registered (stored) in the storage unit (RAM area) 31 of the battery 30 as the first use date information (first use date and time information). Then, the operation goes to step S105.

In step S105, an instruction to start charging the battery 30 is detected. If an instruction to start charging the battery 30 is detected (Yes), the operation goes to step S106. If an instruction to start charging the battery 30 is not detected (No), the operation is repeated.

In step S106, on the basis of the first use date information (first use date and time information), “elapsed time” is computed. For example, “elapsed time” is computed from the first use date information (first use date and time information) and the present time. Then, the operation goes to step S107.

In step S107, the computed “elapsed time” is compared with the elapsed time threshold value stored in the storage unit 113a of the charging value instruction unit (EC/KBC) 113. Then, the operation goes to step S108.

In step S108, it is detected whether the “elapsed time” exceeds “threshold value 1” or it is detected whether the “elapsed time” corresponds to “threshold value 2.” The “threshold value 1” is, for example, elapsed time threshold value 1 (one day through 1000 days). The “threshold value 2” is, for example, elapsed time threshold value 2 (1001 days through 2000 days).

If it is detected that the “elapsed time” exceeds “threshold value 1” or it is detected that the “elapsed time” corresponds to “threshold value 2” (Yes), the operation goes to step S109. If it is detected that the “elapsed time” does not exceed “threshold value 1” or it is detected that the “elapsed time” does not correspond to “threshold value 2” (No), the operation goes to step S110.

In step S109, a “charging value” (e.g., current of 900 mA/voltage of 4.0 V, second value) which corresponds to the “elapsed time” and which is stored in the storage unit 113a of the charging value instruction unit (EC/KBC) 113, is designated. Then, the operation goes to step S111.

In step S110, a “charging value” (e.g., current of 1.5 A/voltage of 4.2 V, first value) which is registered (stored) in the storage unit 113a of the charging value instruction unit (EC/KBC) 113 or the storage unit (RAM area) 31 of the battery 30, is designated. Then, the operation goes to step S111.

In step S111, the designated “charging value” (e.g., the first value or second value) is notified to and stored in the storage unit (register) 41 of the charging control unit (charger) 40. Then, the operation goes to step S112.

In step S112, the charging control unit (charger) 40 performs control for charging the battery 30 by using the notified “charging value”. Then, the operation goes to step S113.

In step S113, the operation ends.

The electronic device (PC) 10 according to the embodiment comprises the charging control unit (charger) 40 for controlling charging the battery 30 with a preset first charging value.

The electronic device (PC) 10 also comprises the first information detector (EC/KBC) 113 which detects “first use date and time information” stored in the storage unit 31 of the battery 30.

The electronic device (PC) 10 also comprises the elapsed time information detector (EC/KBC) 113 which obtains “elapsed time information” based on the detected “first use date and time information” and detects whether the “elapsed time information” corresponds to a preset value.

The electronic device (PC) 10 also comprises the charging instruction unit (EC/KBC) 113 which switches a charging value to a preset second value and gives an instruction to charge the battery 30, when the “elapsed time information” corresponds to the preset value.

If the “first use date and time information” is not detected, the “start date and time information” indicative of the starting time of the OS is stored as the “first use date and time information.”

If the “elapsed time information” does not correspond to the preset value, an instruction to charge the battery with the preset first charging value 30 is given.

The “first use date and time information” is detected in accordance with, for example the start of the OS.

The “elapsed time information” is acquired in accordance with an instruction to charge the battery 30.

The electronic device (PC) 10 also comprises a second charging value storage unit which stores the switched second charging value.

The battery 30 comprises a first use date and time information storage unit which stores the “first use date and time information.”

The charging instruction unit (EC/KBC) 113 stores information used to detect whether the “elapsed time information” corresponds to the preset value.

The above configuration makes it possible to increase user convenience by control of charge particularly without noting a degradation of a battery used in the electronic device in the embodiment.

All the steps of the control process according to the embodiment can be performed by software. For this reason, the same advantage as that of the above embodiment can easily be achieved only by installing a computer program for executing the steps of the control process in a normal computer through computer readable storage medium in which the program is stored.

The above embodiment is not limited to the descriptions themselves. When the invention is reduced to practice, its structural elements can be modified in different ways and embodied without departing from the spirit of the invention.

Furthermore, a variety of inventions can be made by appropriate combinations of the structural elements of the embodiment.

For example, some of the structural elements of the embodiment can be omitted. Moreover, the structural elements of different embodiments can be combined appropriately.

What is claimed is:

1. An electronic device comprising:
a charging controller configured to perform control for charging a battery with a preset first charging value;
a first information detector configured to detect first use date and time information stored in a storage unit of the battery;
an elapsed time information detector configured to obtain elapsed time information based on the detected first use date and time information, and detect whether the elapsed time information corresponds to a preset value; and
a charging instruction module configured to provide an instruction to switch a charging value from the first charging value to a preset second charging value and charge the battery when the elapsed time information corresponds to the preset value.

2. The electronic device of claim 1, wherein when the first use date and time information is not detected, start date and time information of start of an OS is stored as the first use date and time information.

3. The electronic device of claim 1, wherein when the elapsed time information does not correspond to the preset value, an instruction to charge the battery with the first charging value is provided.

4. The electronic device of claim 1, wherein the first use date and time information is detected in accordance with start of an OS.

5. The electronic device of claim 1, wherein the elapsed time information is obtained in accordance with the instruction to charge the battery.

6. The electronic device of claim 1, further comprising a second charging value storage unit configured to store the switched second charging value.

7. The electronic device of claim 1, wherein the battery comprises a first use date and time information storage unit configured to store the first use date and time information.

8. The electronic device of claim 1, wherein the charging instruction module comprises a detection information storage unit configured to store information used to detect whether the elapsed time information corresponds to the preset value.

9. A method for controlling an electronic device, comprising:
performing control for charging a battery with a preset first charging value;
detecting first use date and time information stored in a storage unit of the battery;
obtaining elapsed time information based on the detected first use date and time information, and detecting whether the elapsed time information corresponds to a preset value; and
providing an instruction to change a charging value to a preset second charging value and charge the battery when the elapsed time information corresponds to the preset value.

10. A computer-readable, non-transitory storage medium having stored thereon a computer program which is executable by a computer, the computer program controlling the computer to execute functions of:
performing control for charging a battery with a preset first charging value;
detecting first use date and time information stored in a storage unit of the battery;
obtaining elapsed time information based on the detected first use date and time information, and detecting whether the elapsed time information corresponds to a preset value; and
providing an instruction to change a charging value to a preset second charging value and charge the battery when the elapsed time information corresponds to the preset value.
